(19) United States
(12) Patent Application Publication
(10) Pub. No.: US 2025/0068491 A1
(43) Pub. Date: Feb. 27, 2025

(54) COMMUNICATION METHOD, DEVICE, AND MEDIUM BETWEEN SOFTWARE MODULES

(71) Applicant: Lemon Inc., Grand Cayman (KY)

(72) Inventor: Xinqi XIE, Beijing (CN)

(21) Appl. No.: 18/814,147

(22) Filed: Aug. 23, 2024

(30) Foreign Application Priority Data
Aug. 25, 2023 (CN) 202311086387.2

(51) Int. Cl. G06F 9/54

(52) U.S. Cl. CPC G06F 9/542

(57) ABSTRACT

A communication method, apparatus, device and medium between software modules are provided. The communication method includes: registering, in response to a creation of a first module implemented based on a preset first interface, an accessible service corresponding to the first interface in the first module, and unregistering the accessible service in response to a destruction of the first module; and finding, by a second module, whether the registered accessible service exists, and when the registered accessible service exists, accessing, by the second module, the accessible service.

### CROSS-REFERENCE TO RELATED APPLICATION

This application claims the priority to and benefits of the Chinese Patent Application, No. CN202311086387.2, which was filed on Aug. 25, 2023. The aforementioned patent application is hereby incorporated by reference in its entirety.

### TECHNICAL FIELD

Embodiments of the present disclosure relate to the technical field of computers, and in particular, to a communication method, apparatus, device, and medium between software modules.

### BACKGROUND

Software modules included in software or an application running on various computing terminals may typically communicate in many ways. For example, the software modules may communicate by means of an event bus (EventBus), and methods in other modules may be directly called by reference to other modules. However, these communication ways often have inter-module structural problems, e.g., the type of communication data being unable to be determined, an operation security problem such as memory leak, or a coupling degree between modules increasing.

Therefore, there is a need for a new communication method between software modules.

### SUMMARY

Embodiments of the present disclosure describe a communication method, apparatus, device and medium between software modules.

In a first aspect, a communication method between software modules is provided, comprising: registering, in response to a creation of a first module implemented based on a preset first interface, an accessible service corresponding to the first interface in the first module, and unregistering the accessible service in response to a destruction of the first module; and finding, by a second module, whether the registered accessible service exists, and when the registered accessible service exists, accessing, by the second module, the accessible service.

In a second aspect, a communication method between software modules is provided, comprising: registering, in response to a creation of a first module implemented based on a preset second interface, a subscribable service corresponding to the second interface in the first module, and unregistering the subscribable service in response to a destruction of the first module; and finding, by a second module, whether the registered subscribable service exists, and when the registered subscribable service exists, subscribing, by the second module, for subscribable data of the subscribable service.

In a third aspect, a communication apparatus between software modules is provided, comprising: a first registration unit configured to register, in response to a creation of a first module implemented based on a preset first interface, an accessible service corresponding to the first interface in the first module, and unregister the accessible service in response to a destruction of the first module; and an access unit configured to find, by a second module, whether the registered accessible service exists, and when the registered accessible service exists, access, by the second module, the accessible service.

In a fourth aspect, a communication apparatus between software modules is provided, comprising: a second registration unit configured to register, in response to a creation of a first module implemented based on a preset second interface, a subscribable service corresponding to the second interface in the first module, and unregister the subscribable service in response to a destruction of the first module; and a subscription unit configured to find, by a second module, whether the registered subscribable service exists, and when the registered subscribable service exists, subscribe, by the second module, for subscribable data of the subscribable service.

In a fifth aspect, a computer-readable storage medium is provided, storing a computer program which, when executed by a computer, causes the computer to perform the method in the first aspect and the method in the second aspect.

In a sixth aspect, an electronic device is provided, comprising a memory and a processor, wherein executable codes is stored on the memory, and when the executable codes are executed by the processor, the method in the first aspect and the method in the second aspect are performed.

### BRIEF DESCRIPTION OF DRAWINGS

FIG. 1 illustrates a schematic diagram of a method of communication between software modules according to an embodiment of the present disclosure;

FIG. 2 illustrates a flowchart of a method of communication between software modules according to an embodiment of the present disclosure;

FIG. 3A illustrates a schematic diagram of defining an accessible service interface according to an embodiment of the present disclosure;

FIG. 3B illustrates a schematic diagram of implementing an accessible service interface according to an embodiment of the present disclosure;

FIG. 4 illustrates a schematic diagram of a tree-like module relationship according to an embodiment of the present disclosure;

FIG. 5 illustrates a schematic diagram of finding an accessible service according to an embodiment of the present disclosure;

FIG. 6 illustrates a schematic diagram of accessing an accessible service according to an embodiment of the present disclosure;

FIG. 7 illustrates a flowchart of a method of communication between software modules according to another embodiment of the present disclosure;

FIG. 8A illustrates a schematic diagram of defining a subscribable service interface according to an embodiment of the present disclosure;

FIG. 8B illustrates a schematic diagram of implementing a subscribable service interface according to an embodiment of the present disclosure;

FIG. 9 illustrates a schematic diagram of subscribing for subscribable data of a subscribable service according to an embodiment of the present disclosure;

FIG. 10 illustrates a schematic block diagram of a communication apparatus between software modules according to an embodiment of the present disclosure;

FIG. 11 illustrates a schematic block diagram of a communication apparatus between software modules according to another embodiment of the present disclosure;

FIG. 12 illustrates a schematic structural diagram of an electronic device adapted to implement embodiments of the present disclosure; and

FIG. 13 illustrates a structural schematic diagram of a memory medium adapted to implement embodiments of the present disclosure.

### DETAILED DESCRIPTION

A detailed description of the technical solutions of the present disclosure will be provided hereinbelow with reference to the drawings and embodiments. It can be understood that the embodiments described herein are merely for the purpose of explaining the relevant invention, and do not constitute a limitation on the invention. Furthermore, it should be noted that, for the sake of description, only parts relevant to the invention are shown in the drawings. It needs to be clarified that, where there is no conflict, the embodiments of the present disclosure and the features in the embodiments can be combined with each other.

In the description of embodiments of the present disclosure, the term “comprises” and its variants should be understood as an open-ended inclusion, i.e., “comprising but not limited to.” The term “based on” should be understood as “at least partly based on.” The phrase “one embodiment” or “the embodiment” should be understood as “at least one embodiment.” The term “some embodiments” should be understood as “at least some embodiments.” The following description may include other terms that have explicit and implicit definitions.

As described previously, software modules included in software or an application running on different operating systems may typically communicate with different solutions. For example, by reference to other modules, a module may communicate with other modules by directly invoking methods in other modules. In one example, if module A has a reference to module B for example, data of the module B can be directly accessed, or the method in the module B can be invoked. By virtue of this communication solution, a referencing module can typically perform subsequent logic operations thereof after a referenced module responds. The communication way in this solution is also known as a synchronous communication way. For another example, software modules may also communicate by means of an event bus (EventBus). In one example, module C can publish an event by means of the EventBus, and the module B can receive the event by means of the EventBus and perform a corresponding logic operation after receiving the event. By virtue of this communication solution, after a data sender (which may be an event publication module, for example) sends data (event), subsequent logic operations can be performed not after a data receiver (which may be an event receiving module, for example) responds. The communication way in this solution is also known as an asynchronous communication way.

However, the above-mentioned solution of communication between modules also has the following problems. First, direct reference is made between modules, for example. Due to different life cycles of different modules, the reference to the referenced module by the referencing module still exists when the referenced module has been destructed, thereby leading to a reference error problem. Also, the referenced module might be not recovered in effect at a recovery time, leading to a memory leak problem. Second, a direct reference made between modules may increase the coupling degree between the modules and reduce the logical independence of the modules, for example. Thus, the complexity of a relationship between the modules and the maintenance difficulty of the modules will be increased. Third, modules communicate by means of the event bus, for example. Since the event bus typically does not constrain an event receiver and a type of an event or data sent, problems that an event sending range cannot be defined and that the sent event or data is inconvenient for inspection may arise. Fourth, the above-mentioned communication solution typically has a single communication way which can often be fixed as one of synchronous communication or asynchronous communication and cannot altered to any one or both of them.

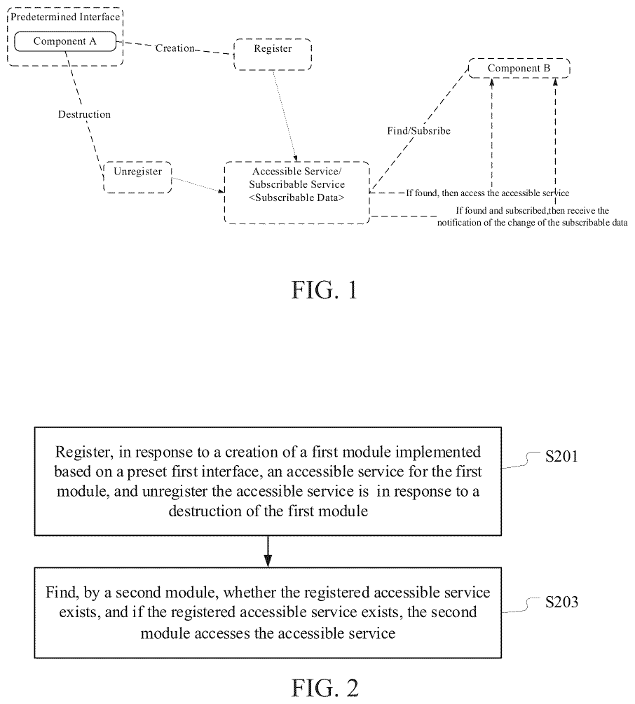

In order to solve the above technical problems, an embodiment of the present disclosure provides a communication method between software modules. FIG. 1 illustrates a schematic diagram of a communication method between software modules according to an embodiment of the present disclosure. As shown in FIG. 1, in some embodiments, when, for example, a first module implementing a predetermined service interface (e.g., a first interface) is created, an accessible service of the first module may be registered; and when the first module is destructed, the accessible service in the first module may be unregistered. For example, if a second module needs to access the accessible service in the first module, the second module may find whether the registered accessible service of the first module exits; and if so, the second module may access the accessible service of the first module. In some other embodiments, when a first module implementing, for example, a predetermined second interface is created, a subscribable service of the first module may be registered; and when the first module is destructed, the subscribable service in the first module may be unregistered. For example, if a second module needs to acquire subscribable data of the subscribable service, the second module may find whether the registered subscribable service of the first module exits; and if so, the second module may subscribe for the subscribable data of the subscribable service of the first module. In yet another embodiments, for example, a first module may implement both a first interface and a second interface. Thus, when the first module is created, an accessible service and a subscribable service of the first module are registered; and when the first module is destructed, the accessible service and the subscribable service of the first module may be unregistered. For example, if a second module desires to, for example, access the accessible service of the first module or acquire subscribable data of the subscribable service, the second module may find whether the registered accessible service or subscribable service of the first module exists; and if so, the second module may access the accessible service of the first module or subscribe for the subscribable data of the subscribable service of the first module.

This method has the following advantages: in a first aspect, a module capable of communication is defined by the implementation of an interface, and an accessible method and subscribable data (e.g., a data type or a sending range thereof) may be constrained by the interface. In a second aspect, an accessible service and a subscribable service of a module can be registered and unregistered automatically according to a life cycle of the module. The problems of reference error and memory leak caused by references between modules having different life cycles may not arise. In a third aspect, communication between different modules does not reply on direct reference, and instead is defined by a preset interface. The coupling degree between modules is reduced, and then the complexity of a relationship between the modules and the maintenance difficulty of the modules will be reduced. In a fourth aspect, a way of communication between modules may be set as any one or both of synchronous communication and asynchronous communication according to a use habit or requirement of a user.

The detailed process of this method is further described below.

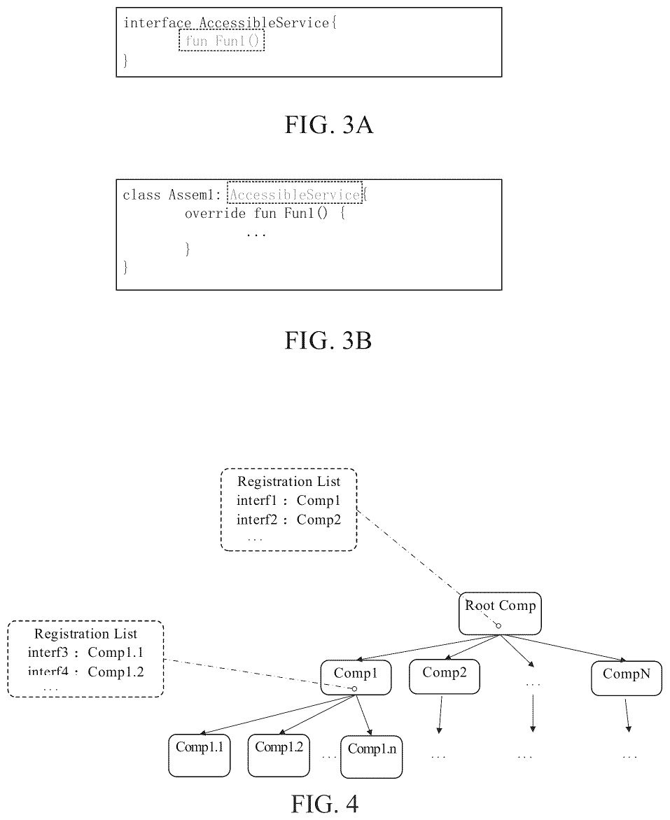

FIG. 2 illustrates a flowchart of a communication method between software modules according to an embodiment of the present disclosure. As shown in FIG. 3, the method includes at least the following steps.

At step S201, in response to a creation of a first module implemented based on a preset first interface, an accessible service corresponding to the first interface in the first module is registered, and the accessible service is unregistered in response to a destruction of the first module.

At step S203, a second module finds whether the registered accessible service exists, and if the registered accessible service exists, the second module accesses the accessible service.

First, at step S201, in response to the creation of the first module implemented based on the preset first interface, the accessible service corresponding to the first interface in the first module is registered, and the accessible service is unregistered in response to the destruction of the first module.

An interface, which is typically an aggregation defined and constituted by a method, has a unique name and can be inherited or implemented by a class or other interfaces. The first interface (or referred to as an accessible service interface) may be configured to define a specific method included in the accessible service. In different specific embodiments, different methods of different accessible services may be defined in the first interface, which will not be defined in this specification. FIG. 3A illustrates a schematic diagram of defining an accessible service interface according to an embodiment of the present disclosure. As shown in FIG. 3A, for example, interface AccessibleService is defined, and this interface includes method Fun1. A module implementing the interface may provide an accessible service. FIG. 3B illustrates a schematic diagram of implementing an accessible service interface according to an embodiment of the present disclosure. As shown in FIG. 3B, for example, a class of Assem1 module is defined to implement the interface AccessibleService so that the Assem1 module can provide the accessible service. In the way described above, a module capable of providing synchronous communication may be provided by implementing or not implementing a corresponding interface, and an accessible method of the module may be constrained by the interface.

In different embodiments, specific ways of registering and unregistering accessible services may be different. In one embodiment, the first module belongs to a plurality of preset modules. The plurality of preset modules and an inheritance relationship between the preset modules constitute a tree-like inheritance relationship diagram. Each preset module has a corresponding service registration list that includes a mapping relationship between a service interface implemented by a currently created sub-module of the preset module and the currently created sub-module. Thus, in response to a creation of the first module, a mapping relationship between the first interface and the first module is added to a service registration list corresponding to a parent module of the first module. Moreover, in response to a destruction of the first module, the mapping relationship between the first interface and the first module is deleted from the service registration list corresponding to the parent module of the first module. FIG. 4 illustrates a schematic diagram of a tree-like module relationship according to an embodiment of the present disclosure. In an example as shown in FIG. 4, for example, a plurality of modules Root Comp, Comp1 to CompN, Comp1.1 to Comp1.n, . . . , and an inheritance relationship between these modules constitute a tree-like inheritance relationship diagram, wherein Root Comp is a root module; Comp1 to CompN are sub-modules inheriting Root Comp; and Comp1.1 to Comp1.n are sub-modules inheriting Comp1. Each module has a corresponding service registration list that includes a mapping relationship between a service interface implemented by a currently created sub-module of the preset module and the currently created sub-module. For example, the service registration list corresponding to module Comp1 may include a mapping relationship between service interface interf3 implemented by currently created sub-module Comp1.1 of the module Comp1 and the sub-module Comp1.1, and a mapping relationship between service interface interf4 implemented by currently created sub-module Comp1.2 of the module Comp1 and the sub-module Comp1.2. As described previously, sub-modules inheriting the module Comp1 may include Comp1.1 to Comp1.n, wherein when any sub-module (or an instance of the sub-module) is created, a mapping relationship between a service interface implemented by the sub-module and the sub-module may be added to the service registration list corresponding to Comp1. Moreover, when the sub-module is destructed, the mapping relationship is deleted from the service registration list corresponding to Comp1. As such, when the first module is created or destructed, the accessible service of the first module is registered or unregistered automatically. In this way described above, an accessible service of a module may be registered or unregistered automatically according to a life cycle of the module. Thus, the problems of reference error and memory leak caused by references between modules having different life cycles may not arise in subsequent steps.

Then, at step S203, the second module finds whether the registered accessible service exists, and if the registered accessible service exists, the second module accesses the accessible service.

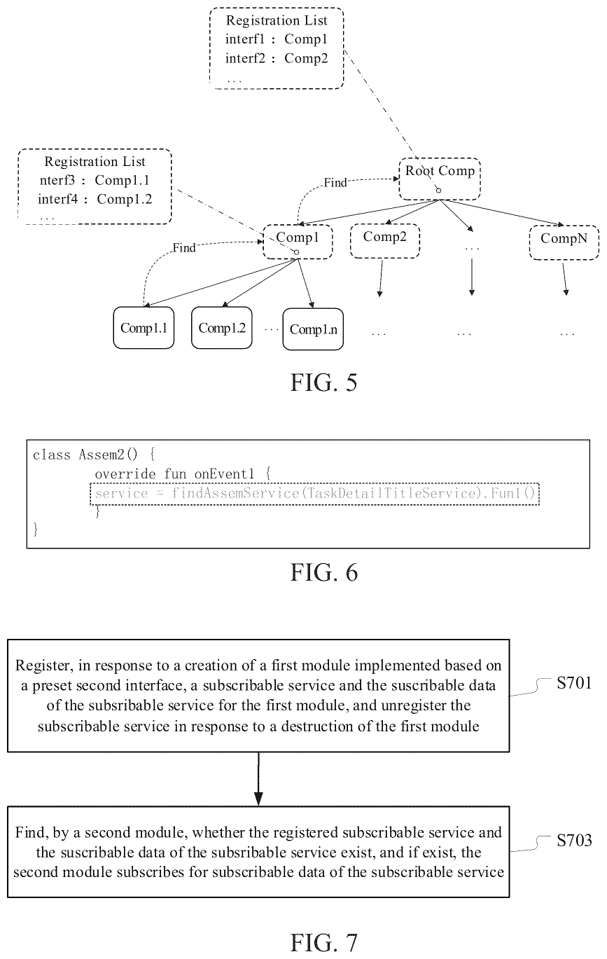

In the embodiment in which the plurality of preset modules and the inheritance relationship therebetween constitute the tree-like inheritance relationship diagram, the second module may belong to the plurality of preset modules. The second module may find whether the mapping relationship between the first interface and the first module exists in a service registration list corresponding to a predecessor module, and if the mapping relationship between the first interface and the first module exists, access the accessible service of the first module. The predecessor module of the second module refers to a module among the plurality of preset module that is directly or indirectly inherited by the second module. In one specific embodiment, predecessor modules are accessed upward according to levels from a predecessor module at a closest level. If the mapping relationship between the first interface and the first module exists in the service registration list of any predecessor module, it may be determined that the first module has a created instance and can access other accessible services by means of the instance. FIG. 5 illustrates a schematic diagram of finding an accessible service according to an embodiment of the present disclosure. As shown in FIG. 5, module Comp1.1, for example, desires to access an accessible service of module Comp2. Comp1.1 may find whether a mapping relationship between Comp2 and a service interface implemented by Comp2 in a service registration list corresponding to a predecessor module of a previous level thereto, e.g., Comp1. If the mapping relationship does not exist in the service registration list of Comp1, whether the mapping relationship exists may be found in the service registration list corresponding to the module of the previous level to Comp1 until the root module Root Comp. If the mapping relationship exists in the service registration list of any predecessor module, finding may be terminated. Moreover, it is determined that the first module has a created instance and accesses other accessible services by means of the instance. If the mapping relationship cannot be found even at the root module, finding may be given up. In the example shown in FIG. 5, the service registration list of the root module Root Comp includes the mapping relationship between Comp2 and the service interface interf2 implemented by Comp2. Therefore, module Comp1.1 may obtain the instance of Comp2 encapsulated by the first interface and call a method of the instance defined by the first interface, e.g., Fun1, as shown in FIG. 6. In this way described above, the synchronous communication between different modules does not reply on direct reference, and instead is defined by a preset interface. The coupling degree between modules is reduced.

When no accessible service is found, accessing the service may be given up. Therefore, in one embodiment, when the registered accessible service does not exist, the second module may not access the accessible service.

FIG. 7 illustrates a flowchart of a communication method between software modules according to another embodiment of the present disclosure. As shown in FIG. 7, the method includes at least the following steps.

At step S701, in response to a creation of a first module implemented based on a preset second interface, a subscribable service corresponding to the second interface in the first module is registered, and the subscribable service is unregistered in response to a destruction of the first module.

At step S703, a second module finds whether the registered subscribable service exists, and if the registered subscribable service exists, the second module subscribes for subscribable data of the subscribable service.

First, at step S701, in response to a creation of the first module implemented based on the preset second interface, the subscribable service corresponding to the second interface in the first module is registered, and the subscribable service is unregistered in response to a destruction of the first module.

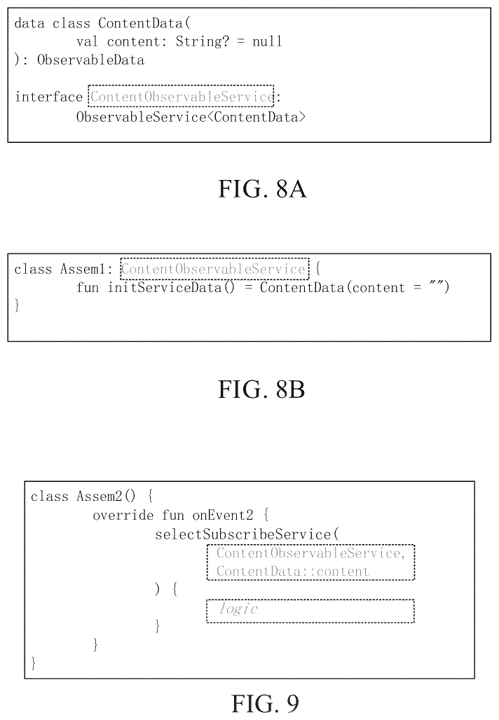

The second interface (or referred to as a subscribable service interface) may be configured to define the subscribable data of the subscribable service. In different specific embodiments, different subscribable data of different subscribable services may be defined in the second interface, which will not be defined in this specification. FIG. 8A illustrates a schematic diagram of defining a subscribable service interface according to an embodiment of the present disclosure. As shown in FIG. 8A, for example, interface ContentObservableService is defined, and the type of the subscribable data of this interface is ContentData. A module implementing the interface may provide a subscribable service. FIG. 8B illustrates a schematic diagram of implementing an accessible service interface according to an embodiment of the present disclosure. As shown in FIG. 8B, for example, a class of Assem1 module is defined to implement the interface ContentObservableService so that the subscribable data of the subscribable service of Assem1 module can subscribed for by other modules. In this way described above, a module capable of providing asynchronous communication may be provided by implementing or not implementing a corresponding interface, and subscribable data of the module may be constrained by the interface.

In this step, the ways of registering and unregistering the subscribable service may be similar to those of registering and unregistering the accessible service in step S201. For the detailed description of the specific registering and unregistering ways, a reference may be made to the description on step S201, which will no longer be repeated here. In one embodiment, in response to a creation of the first module, a mapping relationship between the second interface and the first module is added to a service registration list corresponding to a parent module of the first module. Moreover, in response to a destruction of the first module, the mapping relationship between the second interface and the first module is deleted from the service registration list corresponding to the parent module of the first module.

Then, at step S703, the second module finds whether the registered subscribable service exists, and if the registered subscribable service exists, the second module subscribes for the subscribable data of the subscribable service.

In this step, the way of finding the subscribable service may be similar to that of finding the accessible service in step S203. For the detailed description of the specific finding way, a reference may be made to the description on step S201, which will no longer be repeated here. In one embodiment, the second module may belong to the plurality of preset modules. The second module finds whether the mapping relationship between the second interface and the first module exists in a service registration list corresponding to a predecessor module, and if the mapping relationship between the second interface and the first module exists, subscribes for the subscribable data of the subscribable service.

In one embodiment, after the second module subscribes for the subscribable data of the subscribable service, if the subscribable data changes, the second module may receive a notification of the change. As shown in FIG. 9, if module Assem2 subscribes for subscribable data ContentData of ContentObservableService, a notification may be received after ContentData changes, and a corresponding operation (logic) may also be performed, e.g., after receiving the notification.

In one embodiment, if the registered subscribable service does not exist, the second module does not subscribe for the subscribable data of the subscribable service.

In different embodiments, an accessible service and a subscribable service may be registered for a same module to provide synchronous and asynchronous communication ways for this module. Therefore, in one embodiment, in step S701, in response to a creation of the first module implemented based on preset first and second interfaces, an accessible service corresponding to the first interface and a subscribable service corresponding to the second interface in the first module may be registered; and the accessible service and the subscribable service may be unregistered in response to a destruction of the first module. Thus, in step S703, the second module may find whether the registered subscribable service exists, and if the registered subscribable service exists, the second module subscribes for the subscribable data of the subscribable service; and/or the second module finds whether the registered accessible service exists, and if the registered accessible service exists, the second module accesses the accessible service.

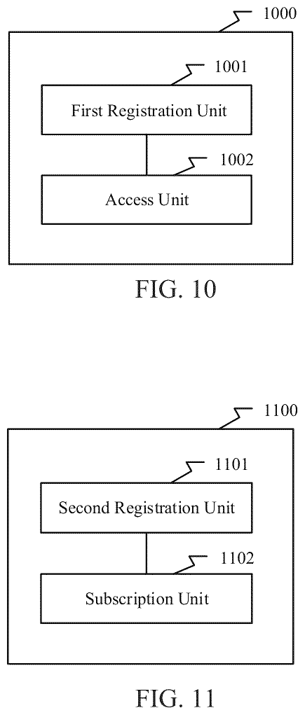

FIG. 10 illustrates a schematic block diagram of a communication apparatus between software modules according to an embodiment of the present disclosure. The apparatus is configured to perform the method as shown in FIG. 2. As shown in FIG. 10, the apparatus 1000 includes: a first registration unit 1001 and an access unit 1002.

The first registration unit 1001 is configured to register, in response to a creation of a first module implemented based on a preset first interface, an accessible service corresponding to the first interface in the first module, and unregister the accessible service in response to a destruction of the first module.

The access unit 1002 is configured to find, by a second module, whether the registered accessible service exists, and if the registered accessible service exists, access, by the second module, the accessible service.

FIG. 11 illustrates a schematic block diagram of a communication apparatus between software modules according to another embodiment of the present disclosure. The apparatus is configured to perform the method as shown in FIG. 7. As shown in FIG. 11, the apparatus 1100 includes: a second registration unit 1101 and a subscription unit 1102.

The second registration unit 1101 is configured to register, in response to a creation of a first module implemented based on a preset second interface, a subscribable service corresponding to the second interface in the first module, and unregister the subscribable service in response to a destruction of the first module.

The subscription unit 1102 is configured to find, by a second module, whether the registered subscribable service exists, and if the registered subscribable service exists, subscribe, by the second module, for subscribable data of the subscribable service.

An embodiment of the present disclosure further provides an electronic device, including a memory and a processor. An executable code is stored on a memory, and when executed by the processor, causes the methods as shown in FIG. 2 and FIG. 7 to be performed.

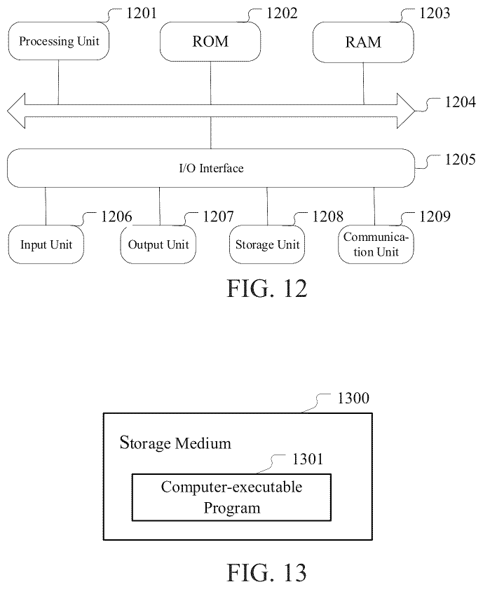

Referring to FIG. 12, which illustrates a structural schematic diagram of an electronic device 1200 adapted to implement the embodiments of the present disclosure. The electronic device 1200 shown in FIG. 12 is merely an example, and should not impose any limitation to the functions and application range of the embodiments of the present disclosure.

As shown in FIG. 12, the electronic device 1200 may include a processing unit (e.g., a central processing unit, a graphics processing unit, etc.) 1201. The processing unit 1201 may be a general-purpose processor, a digital signal processor (DSP), a microprocessor or a microcontroller, and may further include an application specific integrated circuit (ASIC), a field-programmable gate array (FPGA) or other programmable logic devices, discrete gates or transistor logic devices and discrete hardware components. The processing unit can perform various suitable actions and processing according to a program stored on a read-only memory (ROM) 1202 or a program loaded from a storage unit 1208 to a random-access memory (RAM) 1203. The RAM 1203 further stores various programs and data required for operations of the electronic device 1200. The processing unit 1201, the ROM 1202, and the RAM 1203 are connected to one another by means of a bus 1204. An input/output (I/O) interface 1205 is also connected to the bus 1204.

Usually, the following units may be connected to the I/O interface 1205: an input unit 1206 including, for example, a touch screen, a touch pad, a keyboard, a mouse, and the like; an output unit 1207 including, for example, a liquid crystal display (LCD), a loudspeaker, a vibrator, and the like; a storage unit 1208 including, for example, a magnetic tape, a hard disk, and the like; and a communication unit 1209. The communication unit 1209 may allow the electronic device 1200 to be in wireless or wired communication with other devices to exchange data. While FIG. 12 illustrates the electronic device 1200 having various units, it is to be understood that all the illustrated units are not necessarily implemented or included. More or less units may be implemented or included alternatively. Each block shown in FIG. 8 may represent one unit, or may represent a plurality of units as required.

According to the embodiments of the present disclosure, the process described above with reference to the flowchart may be implemented as a computer software program. For example, an embodiment of the present disclosure includes a computer program product including a computer program carried on a computer-readable medium. The computer program includes a program code for performing the method shown in the flowchart. In such an embodiment, the computer program may be downloaded online through the communication apparatus 1209 and installed, or installed from the storage apparatus 1208, or installed from the ROM 1202. When the computer program is executed by the processing apparatus 1201, the functions defined in the communication method between software modules provided in the embodiments of the present disclosure are performed.

An embodiment of the present disclosure further provides a computer-readable storage medium, storing a computer program which, when executed by a computer, causes the computer to perform the communication method between software modules provided by the embodiments of the present disclosure as shown in FIGS. 2 and 7. FIG. 13 is a schematic diagram of a storage medium according to an embodiment of the present disclosure. For example, as shown in FIG. 13, the storage medium 1300 may be a non-transitory computer-readable storage medium and is configured to store non-transitory computer-executable instructions 1301. When the non-transitory computer-executable instructions 1301 are executed by a processor, the communication method between software modules provided by the embodiments of the present disclosure can be implemented. For example, when the non-transitory computer-executable instructions 1301 are executed by the processor, one or more steps of the communication method between software modules provided by the embodiments of the present disclosure can be performed. For example, the storage medium 1300 may be applied to the electronic device described above. For example, the storage medium 1300 may include the memory in the electronic device. For the description regarding the storage medium 1300 may be known with reference to the description of the memory in the embodiment of the electronic device, which will not be described here redundantly. The specific functions and the technical effects of the storage medium 1300 may be known with reference to the above description regarding the communication method between software modules provided by the embodiments of the present disclosure, which will not be described here redundantly.

A communication method, apparatus, device and medium between software modules are provided according to the embodiments of the present disclosure. An accessible service or a subscribable service of a first module may be registered in response to creation of the first module. The first module is implemented based on a preset first interface or second interface. The accessible service or the subscribable service in the first module may be unregistered in response to the destruction of the first module. A second module then finds whether the registered accessible service or subscribable service exists. If the registered accessible service or subscribable service exists, the second module accesses the accessible service or subscribes for subscribable data of the subscribable service. By this method, modules providing synchronous or asynchronous services may be defined by the implementation of interfaces to reduce a coupling degree between the modules, the security problems such as memory leak caused by references between modules having different life cycles may be avoided.

It should be noted that the computer-readable medium of the embodiments of the present disclosure can be a computer-readable signal medium or a computer-readable storage medium, or any combination thereof. Computer-readable storage media, for example, can be—but are not limited to—electrical, magnetic, optical, electromagnetic, infrared, or semiconductor systems, devices, or components, or any combination thereof. More specific examples of computer-readable storage media can include, but are not limited to: an electrical connection with one or more wires, a storage card in a smart phone, a storage component in a tablet, a disk in a portable computer, a hard disk in a personal computer, random access memory (RAM), read-only memory (ROM), erasable programmable read-only memory (EPROM or flash memory), optical fibers, a portable compact disc read-only memory (CD-ROM), optical storage devices, magnetic storage devices, or any suitable combination thereof. In the embodiments of the present disclosure, a computer-readable storage medium can be any tangible medium containing or storing a program that can be used by or in connection with an instruction execution system, apparatus, or device. In the embodiments of the present disclosure, a computer-readable signal medium may include data signals propagated in a baseband or as part of a carrier wave, carrying computer-readable program code. Such propagating data signals may take many forms, including, but not limited to, electromagnetic signals, optical signals, or any suitable combination thereof. A computer-readable signal medium may also be any computer-readable medium other than a computer-readable storage medium, which can transmit, propagate, or convey programs for use by or in connection with an instruction execution system, apparatus, or device. Program code contained on a computer-readable medium may be transmitted using any appropriate medium, including but not limited to: wire, optical cable, RF (Radio Frequency), etc., or any suitable combination thereof.

The aforementioned computer-readable medium may be included in the aforementioned electronic device; or alternatively, it may exist independently without being integrated into the electronic device. The aforementioned computer-readable medium carries one or more programs, and when the one or more programs are executed by the server, they enable the electronic device to implement the communication method between software modules provided by the embodiments of the present application.

The computer program code for carrying out the operations of the present disclosure may be written in one or more programming languages or their combinations, including object-oriented programming languages such as Java, Smalltalk, C++, and also including conventional procedural programming languages such as the “C” language or similar programming languages. The program code may be executed on the user's computer, or partly on the user's computer, as a stand-alone package, partly on the user's computer and partly on a remote computer, or entirely on a remote computer or server. In the situations that a remote computer is involved, the remote computer can be connected to the user's computer through any kind of network, including: a local area network (LAN) or a wide area network (WAN), or can be connected to an external computer (for example, by using an Internet Service Provider to connect to the Internet).

The flowcharts and block diagrams in the Figures illustrate the architecture, functionality, and operation of possible implementations of systems, methods, and computer program products according to various embodiments of the present disclosure. In this regard, each block in the flowchart or block diagram may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending on the functionality involved. It should also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. In the embodiments of the present disclosure involving units, the units can be implemented in software or hardware. The names of the units in certain cases do not constitute a limitation on the units themselves. The functions described herein can be at least partially implemented by one or more hardware logic components. For example, without limitation, exemplary types of hardware logic components that can be used include: Field Programmable Gate Arrays (FPGAs), Application Specific Integrated Circuits (ASICs), Application Specific Standard Products (ASSPs), System on a Chip (SoCs), Complex Programmable Logic Devices (CPLDs), and so forth.

The various embodiments described in this specification are presented in a progressive manner, where common or similar parts among different embodiments can be cross-referred to for understanding; each embodiment primarily highlights its differences from other embodiments. For the embodiments concerning storage media and computing device implementations, due to their fundamental similarities to the method embodiments, they are described relatively briefly, and the sections describing the method embodiments can be referenced for details.

The above description merely provides exemplary embodiments of the present disclosure as well as explanations of the principles of the applied technologies. Those skilled in the art should understand that the scope of the disclosure herein is not limited to technical solutions formed by the specific combinations of the aforementioned technical features, but also covers other technical solutions formed by any combinations of the aforementioned technical features or their equivalent features without departing from the concept of the disclosure. For example, technical solutions formed by substituting the aforementioned features with (but not limited to) other features having similar functions as disclosed herein. Furthermore, although operations have been depicted in a particular order in the figures, this should not be understood as requiring that these operations be performed in the illustrated specific order or sequential order, or that all illustrated operations must be performed, to achieve desirable results. In certain environments, multitasking and parallel processing may be advantageous. Similarly, while numerous specific details are set forth in the detailed description in order to provide a thorough understanding of the subject disclosure, these details should not be interpreted as limiting the scope of the disclosure. Certain features that are described in this disclosure in the context of separate embodiments can also be implemented in combination in a single embodiment. Conversely, various features that are described in the context of a single embodiment can also be implemented in multiple embodiments separately or in any suitable subcombination.

The foregoing detailed embodiments further provide description of the objectives, technical solutions, and beneficial effects of the embodiments of the present invention. Although the subject matter has been described using language specific to structural features and/or methodological acts, it is to be understood that the subject matter defined in the appended claims is not necessarily limited to the specific features or actions described above. Instead, the specific features and actions described above are merely illustrative forms of implementing the claims. It should be understood that the foregoing embodiments are only specific embodiments of the present invention and are not intended to limit the scope of protection of the invention. Any modification, equivalent substitution, improvement, etc., made on the basis of the technical solutions of the invention shall fall within the scope of protection of the invention.

1. A communication method between software modules, comprising:
registering, in response to a creation of a first module implemented based on a preset first interface, an accessible service corresponding to the first interface in the first module, and unregistering the accessible service in response to a destruction of the first module;
finding, by a second module, whether the registered accessible service exists, and when the registered accessible service exists, accessing, by the second module, the accessible service.

2. The method according to claim 1, further comprising:
when the registered accessible service does not exist, refraining the second module from accessing the accessible service.

3. The method according to claim 1, wherein the first module belongs to a plurality of preset modules; the plurality of preset modules and an inheritance relationship between the plurality of preset modules constitute a tree-like inheritance relationship diagram; each of the plurality of preset modules has a corresponding service registration list that includes a mapping relationship between a currently created sub-module of the preset module and a service interface implemented by the currently created sub-module;
wherein the registering, in response to a creation of a first module implemented based on a preset first interface, an accessible service corresponding to the first interface in the first module comprises:
in response to the creation of the first module, adding a mapping relationship between the first interface and the first module to a service registration list corresponding to a parent module of the first module; and
wherein the unregistering the accessible service in response to the destruction of the first module comprises:
in response to the destruction of the first module, deleting the mapping relationship between the first interface and the first module from the service registration list corresponding to the parent module of the first module.

4. The method according to claim 3, wherein the second module belongs to the plurality of preset modules; and
wherein the finding, by a second module, whether the registered accessible service exists, and when the registered accessible service exists, accessing, by the second module, the accessible service comprise:
finding, by the second module, whether the mapping relationship between the first interface and the first module exists in a service registration list corresponding to a predecessor module, and when the mapping relationship between the first interface and the first module exists, accessing the accessible service of the first module.

5. A communication method between software modules, comprising:
registering, in response to a creation of a first module implemented based on a preset second interface, a subscribable service corresponding to the second interface in the first module, and unregistering the subscribable service in response to a destruction of the first module; and
finding, by a second module, whether the registered subscribable service exists, and when the registered subscribable service exists, subscribing, by the second module, for subscribable data of the subscribable service.

6. The method according to claim 5, further comprising:
after subscribing, by the second module, for the subscribable data of the subscribable service, when the subscribable data changes, receiving, by the second module, a notification of the change.

7. The method according to claim 5, further comprising:
when the registered subscribable service does not exist, refraining the second module from subscribing for the subscribable data of the subscribable service.

8. The method according to claim 5, wherein the first module belongs to a plurality of preset modules; the plurality of preset modules and an inheritance relationship between the plurality of preset modules constitute a tree-like inheritance relationship diagram; each of the plurality of preset modules has a corresponding service registration list that includes a mapping relationship between a currently created sub-module of the preset module and a service interface implemented by the currently created sub-module;
wherein the registering, in response to a creation of a first module implemented based on a preset second interface, a subscribable service corresponding to the second interface in the first module comprises:
in response to the creation of the first module, adding a mapping relationship between the second interface and the first module to a service registration list corresponding to a parent module of the first module; and
wherein the unregistering the subscribable service in response to a destruction of the first module comprises:
in response to the destruction of the first module, deleting the mapping relationship between the second interface and the first module from the service registration list corresponding to the parent module of the first module.

9. The method according to claim 8, wherein the second module belongs to the plurality of preset modules;
the finding, by a second module, whether the registered subscribable service exists, and when the registered subscribable service exists, subscribing, by the second module, for subscribable data of the subscribable service comprise:
finding, by the second module, whether the mapping relationship between the second interface and the first module exists in a service registration list corresponding to a predecessor module, and when the mapping relationship between the second interface and the first module exists, subscribing for the subscribable data of the subscribable service.

10. The method according to claim 5, wherein
the registering, in response to a creation of a first module implemented based on a preset second interface, a subscribable service corresponding to the second interface in the first module, and unregistering the subscribable service in response to a destruction of the first module comprise:
registering, in response to the creation of the first module implemented based on preset first and second interfaces, an accessible service corresponding to the first interface and a subscribable service corresponding to the second interface in the first module; and unregistering the accessible service and the subscribable service in response to the destruction of the first module;
the finding, by a second module, whether the registered subscribable service exists, and when the registered subscribable service exists, subscribing, by the second module, for subscribable data of the subscribable service comprise:
finding, by the second module, whether the registered subscribable service exists, and when the registered subscribable service exists, subscribing, by the second module, for the subscribable data of the subscribable service; and/or
finding, by the second module, whether the registered accessible service exists, and when the registered accessible service exists, accessing, by the second module, the accessible service.

11. A communication apparatus between software modules, comprising:
at least a processor; and
a non-transitory memory with instructions thereon,
wherein the instructions upon execution by the processor, cause the processor to:
register, in response to a creation of a first module implemented based on a preset first interface, an accessible service corresponding to the first interface in the first module, and unregister the accessible service in response to a destruction of the first module; and
find, by a second module, whether the registered accessible service exists, and when the registered accessible service exists, access, by the second module, the accessible service.

12. The apparatus according to claim 11, the processor is further caused to:
when the registered accessible service does not exist, refrain the second module from accessing the accessible service.

13. The apparatus according to claim 11, wherein the first module belongs to a plurality of preset modules; the plurality of preset modules and an inheritance relationship between the plurality of preset modules constitute a tree-like inheritance relationship diagram; each of the plurality of preset modules has a corresponding service registration list that includes a mapping relationship between a currently created sub-module of the preset module and a service interface implemented by the currently created sub-module;
wherein the processor is further caused to:
in response to the creation of the first module, add a mapping relationship between the first interface and the first module to a service registration list corresponding to a parent module of the first module; and
in response to the destruction of the first module, delete the mapping relationship between the first interface and the first module from the service registration list corresponding to the parent module of the first module.

14. The apparatus according to claim 13, wherein the second module belongs to the plurality of preset modules; and
wherein the processor is further caused to:
find, by the second module, whether the mapping relationship between the first interface and the first module exists in a service registration list corresponding to a predecessor module, and when the mapping relationship between the first interface and the first module exists, access the accessible service of the first module.

15. A communication apparatus between software modules, comprising: comprising: at least a processor; and a non-transitory memory with instructions thereon, wherein the instructions upon execution by the processor, cause the processor to perform the method according to claim 5.

16. The apparatus according to claim 15, the processor is further caused to:
after subscribing, by the second module, for the subscribable data of the subscribable service, when the subscribable data changes, receive, by the second module, a notification of the change.

17. The apparatus according to claim 15, the processor is further caused to:
when the registered subscribable service does not exist, refrain the second module from subscribing for the subscribable data of the subscribable service.

18. A computer-readable storage medium, storing a computer program which, when executed by a computer, causes the computer to perform the method according to claim 1.

19. An electronic device, comprising a memory and a processor, wherein executable codes is stored on the memory, and when the executable codes are executed by the processor, the method according to claim 1.
